(19) United States
(12) Patent Application Publication
(10) Pub. No.: US 2024/0359172 A1
(43) Pub. Date: Oct. 31, 2024

(54) Anion Exchange Resins

(71) Applicant: The Johns Hopkins University, Baltimore, MD (US)

(72) Inventor: Luke P. Skala, Baltimore, MD (US)

(73) Assignee: The Johns Hopkins University, Baltimore, MD (US)

(21) Appl. No.: 18/638,877

(22) Filed: Apr. 18, 2024

Related U.S. Application Data
(60) Provisional application No. 63/462,651, filed on Apr. 28, 2023.

(51) Int. Cl. B01J 41/14; B01D 53/62; B01D 53/81; B01J 41/05; B01J 47/02; C02F 1/42; C02F 101/36; C02F 103/00; C08F 212/14; C08F 212/36

(52) U.S. Cl. CPC B01J 41/14; B01D 53/62; B01D 53/81; B01J 41/05; B01J 47/02; C02F 1/42; C08F 212/28; C08F 212/36; B01D 2253/206; B01D 2257/504; B01D 2259/40086; C02F 2001/422; C02F 2101/36; C02F 2103/007; C08F 2810/20

(57) ABSTRACT

An anion exchange resin includes a cross-linked polymer having a plurality of pseudo +2 point charges including dicationic groups. The dicationic groups include a first cationic group and a second cationic group, and a distance between the first cationic group and the second cationic group is from about 1 Angstrom to about 10 Angstroms.

### CROSS-REFERENCE TO RELATED APPLICATIONS

This application claims priority to and the benefit of prior-filed, co-pending U.S. Provisional Application No. 63/462,651, filed on Apr. 28, 2023, the entire content of which is herein incorporated by reference.

### TECHNICAL FIELD

Example embodiments relate generally to anion exchange resins having a cross-linked polymer including a plurality pseudo +2 point charges. The plurality of pseudo +2 charges include dicationic groups including a first cationic group and a second cationic group located in close proximity to each other to mimic a +2 charge. The anion exchange resins provide for the sequestering of a variety of target materials from liquid and/or gaseous mediums.

### BACKGROUND

Per- and polyfluoroalkyl substances (PFAS), also known as “forever chemicals,” are a class of surfactants commonly used in nonstick cookware, firefighting foams, paints, pesticides, fast food packaging, shampoo, and more. The ubiquitous use of these chemicals has resulted in the release of these chemicals into the environment including drinking water supplies. The release of these chemicals is particularly problematic due to their long environmental half-life and their toxicity to human health at trace concentrations. For example, high concentrations of PFAS in drinking water has been linked with reproductive issues, decreased vaccine response, increased cholesterol levels, changes in liver enzymes, and increased risk of cancer. These concerns along with the environmental hazards of PFAS has resulted in strict regulations on PFAS content in municipal drinking water supplies. For example, the current limit for perfluorooctanoic acid (PFOA), a common PFAS pollutant, is currently 0.004 parts per trillion (ppt). Such low regulatory concentrations along with the amphiphilic nature of PFAS has made remediation of these pollutants to be an immense challenge. Present remediation efforts have focused on the use of granular activated carbon (GAC) to remediated these difficult to remove pollutants. However, recent studies have proven GAC to be ineffective at efficiently remediating PFAS due to their low adsorption capacities, slow kinetics, and low affinity for PFAS.

Anion ion exchange resins are an alternative technology which has been proven to be both more efficient and cost effective for the remediation of PFAS. These materials use their inherent cationic charge to attract PFAS which is predominately anionic. Despite the improvements of anion ion exchange resins these materials still require further development to improve their adsorption capacity for PFAS, their selectivity for PFAS, as well as their ability to remediate shorter chain PFAS.

Therefore, there remains a significant and long-felt need for a technology that provides sequestering of a variety of target materials, such as PFAS, heavy metals, and/or carbon dioxide (CO₂).

### BRIEF SUMMARY

One or more example embodiments address one or more of the aforementioned problems. Certain example embodiments include an anion exchange resin. The anion exchange resin includes a cross-linked polymer having a plurality of pseudo +2 point charges including dicationic groups. The dicationic groups include a first cationic group and a second cationic group, and a distance between the first cationic group and the second cationic group is from about 1 Angstrom to about 10 Angstroms . . .

Another example embodiment includes a device. The device includes a chamber, which defines an interior cavity and has a fluid inlet and, optionally, a fluid outlet, each being in operative communication with the interior cavity. The chamber also has an anion exchange resin. The anion exchange resin includes a cross-linked polymer having a plurality of pseudo +2 point charges including dicationic groups. The dicationic groups include a first cationic group and a second cationic group, and a distance between the first cationic group and the second cationic group is from about 1 Angstrom to about 10 Angstroms, and the anion exchange resin is provided in the form of a plurality of particulates confined within the interior cavity.

In yet another example embodiment, a method of sequestering a target material of interest from a fluid containing the target material includes contacting the fluid containing the target material with an anion exchange resin. The anion exchange resin includes a cross-linked polymer having a plurality of pseudo +2 point charges including dicationic groups. The dicationic groups include a first cationic group and a second cationic group. A distance between the first cationic group and the second cationic group is from about 1 Angstrom to about 10 Angstrom.

Still another example embodiment includes a method of making an anion exchange resin. The method includes providing a diamine compound and reacting the diamine compound with an organohalogen compound to form a first precursor compound. The method further includes reacting the first precursor compounds with an unsaturated organohalogen compound to form a dicationic unsaturated monomer, and reacting the dicationic unsaturated monomer with a cross-linker having at least two reactive functionalities to form a cross-linked polymer.

### BRIEF DESCRIPTION OF THE DRAWINGS

Example embodiments will be described more fully hereinafter with reference to the accompanying drawings, in which some, but not all, example embodiments are shown. Indeed, alternative example embodiments may take many different forms and should not be construed as limited to the examples shown or set forth herein; rather, these example embodiments are provided so that this disclosure will satisfy applicable legal requirements. Like numbers refer to like elements throughout, and:

FIG. 1 is a chart illustrating data related to the removal of per- and polyfluoroalkyl substances (PFAS) for two different anion exchange resins according to certain example embodiments compared to granular activated carbon (GAC);

FIG. 2 is a graph illustrating data related to the removal of PFAS over time for two different anion exchange resins according to certain example embodiments compared to GAC;

FIGS. 3A and 3B are graphs illustrating data related to capacity determination for two different anion exchange resins according to certain example embodiments;

FIG. 4 is a chart illustrating data related to the removal of perfluorooctanoic acid (PFOA) for two different anion exchange resins according to example embodiments compared to two commercial resins;

FIG. 5 is a chart illustrating data related to assessing the ability for two different anion exchange resins according to example embodiments to resist fouling compared to two commercial resins;

FIG. 6 is a chart illustrating data related to the removal percentage for two different anion exchange resins according to example embodiments compared to two commercial resins;

FIG. 7 is a chart illustrating data related to test results for the removal of a mixture of 18 types of PFAS;

FIG. 8 illustrates a schematic process of removal of carbon dioxide from air on a submarine in accordance with example embodiments;

FIG. 9 illustrates visual contrast between dicationic resins according to example embodiments compared to traditional monocationic resins;

FIG. 10 is a graph illustrating data related to the amount of carbon dioxide sequestered by an anion exchange resin according to example embodiments over time; and

FIG. 11 is a graph illustrating data related to the subsequent desorption of carbon dioxide previously sequestered onto an anion exchange resin according to example embodiments.

### DETAILED DESCRIPTION

Example embodiments now will be described more fully with reference to the accompanying drawings, in which some, but not all, example embodiments are shown and will hereinafter be further described. As used herein, and in the appended claims, the singular forms “a”, “an,” and “the” include plural referents unless the context clearly dictates otherwise.

Example embodiments relate generally to anion exchange resins having a cross-linked polymer including a plurality of pseudo +2 point charges. The plurality of pseudo +2 charges include dicationic groups including a first cationic group and a second cationic group located in close proximity to each other to mimic a +2 charge. The anion exchange resins provide for the sequestering of a variety of target materials from liquid and/or gaseous mediums. As noted above, for example, new limits on per- and polyfluoroalkyl substances (PFAS) have made remediation of these compounds an increasingly important and challenging endeavor. Ion exchange resins have emerged as a promising solution due to their ability to sequester PFAS with both electrostatic and hydrophobic interactions. In this regard, one example embodiment provides anionic exchange resins that provide an improved performance, such as improved sequestering capacity, rate of sequestering, and/or selectivity for shorter chain PFAS. Traditional anion exchange technologies rely on monovalent cationic groups, which are diffusely distributed throughout the resin's polymer network. Contrary to this traditional approach, example embodiments provide a resin that the incorporates dicationic groups, which may functionally perform as a pseudo +2 charge, and provides exceptionally high affinity for anionic PFAS, among other target materials (e.g., a variety of heavy metals, carbon dioxide [CO₂], etc.). As discussed in more detail below, for example, one example embodiment only required adsorbent loadings of 0.5 milligrams (mg) per liter (L) (mg/L) to remove more than 95 percent (%) of 2 parts per billion (ppb) perfluorooctanoic acid (PFOA). Additionally, this example embodiment exhibited an exceptionally high capacity for PFOA reaching over 2000 milligrams per gram (g or gm) of the anionic exchange resin (e.g., cross-linked polymer). Similarly, this example embodiment was shown to effectively capture carbon dioxide from a gaseous source including carbon dioxide.

Although the target material of interest for sequestering is not limited to PFAS, non-limiting examples of PFAS include perfluorohexanoic acid (PFHxA), perfluorononanoic acid (PFNA), perfluorohexanesulfonic acid (PFHxS), perfluoroheptanoic acid (PFHpA), perfluorobutanesulfonic acid (PFBS), and GENX™ (e.g., a chemical process that uses 2,3,3,3-tetrafluoro-2-(heptafluoropropoxy) propanoic acid (FRD-903) and produces 2,3,3,3-tetrafluoro-2-(heptafluoropropoxy) propanoate (FRD-902) and heptafluoropropyl 1,2,2,2-tetrafluoroethyl ether (E1), in which the chemicals are used in products such as food packaging, paints, cleaning products, non-stick coatings, outdoor fabrics, and firefighting foam. Although the target material of interest for sequestering is not limited to heavy metals, which may have a density above 3.5 grams per cubic centimeter (g/cm³), or about above 7 g/cm³, or about 10 g/cm³, non-limiting examples of heavy metals include mercury (Hg), cadmium (Cd), arsenic (As), chromium (Cr), thallium (TI), lead (Pb), uranium (U) or any combination thereof. In this regard, example embodiments provide for the extraction and/or remediation of a variety of heavy metals. Additionally, or alternatively, the target material of interest may include a variety of sulfates (e.g., sulfate remediation), a variety of phosphates (e.g., phosphate remediation associated with pollution from fertilizers), nitrogen compounds, (e.g., nitrogen remediation associated with pollution from fertilizers), perchlorates (e.g., perchlorate remediation). Additionally, or alternatively, the target material of interest may include a compound in gaseous form, such as carbon dioxide (e.g., direct air capture). In accordance with example embodiments, the target material of interest sequestered by an anion exchange resin, such as those described and disclosed herein, may include one or more of the foregoing materials. It should be noted, however, that the foregoing materials are examples only, and the anion exchange resin in accordance with example embodiments may be utilized to sequester a wide variety of substances.

Example embodiments provide an anion exchange resin including a cross-linked polymer including a plurality pseudo +2 point charges. The plurality of pseudo +2 charges include dicationic groups including a first cationic group and a second cationic group located in close proximity to each other. The instance, a distance between the first cationic group and the second cationic group may be from about 1 to about 10 Angstroms (Å), such as at least about any of the of the following: 1, 1.2, 1.5, 1.8, 2, 2.2, 2.5, 2.8, 3, 3.2, 3.5, 3.8, 4, 4.2, 4.5, 4.8, and 5 Angstroms, and/or at most about any of the following: 10, 9.5, 9, 8.5, 8, 7.5, 7, 6.5, 6, 5.5, and 5 Angstroms. In accordance with example embodiments, the dicationic groups may be grafted onto and/or within the cross-linked polymer network or structure.

In accordance with example embodiments, the cross-linked polymer includes a plurality of cyclic organic groups including a respective dicationic group or groups, wherein the plurality of cyclic organic groups may include from 1 to about 6 rings, such as at least about any of the following: 1, 2, and 3 rings, and/or from at most about any of the following: 6, 5, 4, and 3 rings. For example, each ring may include from about 3 to about 12 carbon atoms, such as at least about any of the following: 3, 4, 5, and 6 carbon atoms, and/or at most about any of the following: 12, 11, 10, 9, 8, 7, and 6 carbon atoms. Additionally, or alternatively, the cyclic organic groups may include heterocyclic groups including both carbon atoms and nitrogen atoms forming part of the ring structure.

By way of example, the cross-linked polymer includes a plurality of 1,4-Diazabicyclo[2.2.2]octane (DABCO) groups (e.g., bicyclic molecule) each including a respective dicationic group. In accordance with example embodiments, the DABCO groups may be incorporated into a monomer that may be grafted onto and/or within the cross-linked polymer network or structure. In accordance with example embodiment, each DABCO group (e.g., DABCO-containing group) independently from each other may have a structure according to structure (1):

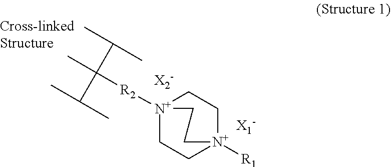

wherein,

R₁ is selected from a saturated or unsaturated linear hydrocarbon radical, a saturated or unsaturated branched hydrocarbon radical, a saturated or unsaturated linear hydrocarbon radical substituted with at least one heteroatom, a saturated or unsaturated branched hydrocarbon radical substituted with at least one heteroatom, a saturated or unsaturated cyclic hydrocarbon radical, a saturated or unsaturated heterocyclic hydrocarbon radical; wherein the at least one heteroatom is selected from an oxygen atom or a nitrogen atom;

R₂ is selected from an acrylate functional group diradical, a saturated or unsaturated linear hydrocarbon diradical, a saturated or unsaturated branched hydrocarbon diradical, a saturated or unsaturated linear hydrocarbon diradical substituted with at least one heteroatom, a saturated or unsaturated branched hydrocarbon diradical substituted with at least one heteroatom, a saturated or unsaturated cyclic hydrocarbon diradical, a saturated or unsaturated heterocyclic hydrocarbon diradical; wherein the at least one heteroatom is selected from an oxygen atom or a nitrogen atom; wherein the at least one heteroatom is selected from an oxygen atom or a nitrogen atom; and

X₁ and X₂ are each a negatively charged species, such as a halide atom.

As used herein, the term “radical” may refer to an organic group bonded to another group (e.g., an organic group missing a hydrogen atom due to a bond formed with another entity), and the term “diradical” may refer to an organic group bonded to two other groups (e.g., an organic group missing two hydrogen atoms due to bonds formed with two other groups).

In accordance with example embodiments, R₁ in Structure 1 may include from 1 to 6 additional DABCO groups, such as at least about any of the following: 1, 2, and 3 additional DABCO groups, and/or at most about any of the following: 6, 5, 5, and 3 additional DABCO groups. In this regard, a plurality of DABCO groups may be provided in the same chain extending from the general cross-linked structure. Additionally, or alternatively, R₁ may include a C1-C12 hydrocarbon (e.g., at least about any of the following: 1, 2, 3, 4, 5, and 6 carbon atoms, and/or at most about any of the following: 12, 11, 10, 9, 8, 7, and 6 carbon atoms) between each additional DABCO group. In this regard, the plurality of DABCO groups within R₁ may be selectively bunched together or spaced-apart as desired.

R₁ in Structure 1, in accordance with example embodiments, may include from about 1 to about 50 carbon atoms, such as at least about any of the following: 1, 2, 3, 6, 8, 10, 12, 15, 18, 20, 22, and 25 carbon atoms, and/or at most about any of the following: 50, 48, 45, 42, 40, 38, 35, 32, 30, 28, and 25 carbon atoms. In this regard, the allotment of the carbon atoms may be embodied in a variety of structural configurations (e.g., linear, branched, cyclic, and combinations thereof).

In accordance with example embodiments, R₁ in Structure 1 may include at least one monocationic group, such as a quaternary ammonium compound. In this regard, the cross-linked polymer may include a combination of dicationic groups and monocationic groups.

In accordance with example embodiments, R₁ in Structure 1 may include (i) an alkyl group having from 1 to about 30 carbon atoms, such as at least about any of the following: 1, 2, 3, 5, 8, 10, 12, and 15 carbon atoms, and/or at most about any of the following: 30, 28, 25, 22, 20, 18, and 15 carbon atoms, and/or (ii) a cycloalkyl group having from 1 to about 30 carbon atoms, such as at least about any of the following: 1, 2, 3, 5, 8, 10, 12, and 15 carbon atoms, and/or at most about any of the following: 30, 28, 25, 22, 20, 18, and 15 carbon atoms.

In accordance with example embodiments, R₂ in Structure 1 may include from about 1 to about 50 carbon atoms, such as at least about any of the following: 1, 2, 3, 6, 8, 10, 12, 15, 18, 20, 22, and 25 carbon atoms, and/or at most about any of the following: 50, 48, 45, 42, 40, 38, 35, 32, 30, 28, and 25 carbon atoms. Additionally or alternatively, R₂ may include (i) a hydrocarbon having from 1 to about 30 carbon atoms, such as at least about any of the following: 1, 2, 3, 5, 8, 10, 12, and 15 carbon atoms, and/or at most about any of the following: 30, 28, 25, 22, 20, 18, and 15 carbon atoms, and/or (ii) a cyclic hydrocarbon having from 1 to about 30 carbon atoms, such as at least about any of the following: 1, 2, 3, 5, 8, 10, 12, and 15 carbon atoms, and/or at most about any of the following: 30, 28, 25, 22, 20, 18, and 15 carbon atoms.

In accordance with example embodiments, the dicationic groups can be incorporated into the cross-linked polymer via a wide variety of reactive monomers containing one or more dicationic groups as generally described above with respect to Structure 1, which illustrates a dicationic-containing monomer incorporated into the cross-linked polymer. In this regard, dicationic-containing monomers are not particularly limited in a structural manner, but would preferably include a terminal reactive group available for reacting with additional monomers for formation of the cross-linked polymer. Terminal reactive groups can include, for example, unsaturated groups including double bonds (C═C) or triple bonds (C≡C). By way of non-limiting examples only, the following list of example dicationic-containing monomers (e.g., dicationic vinyl monomers) may include the following:

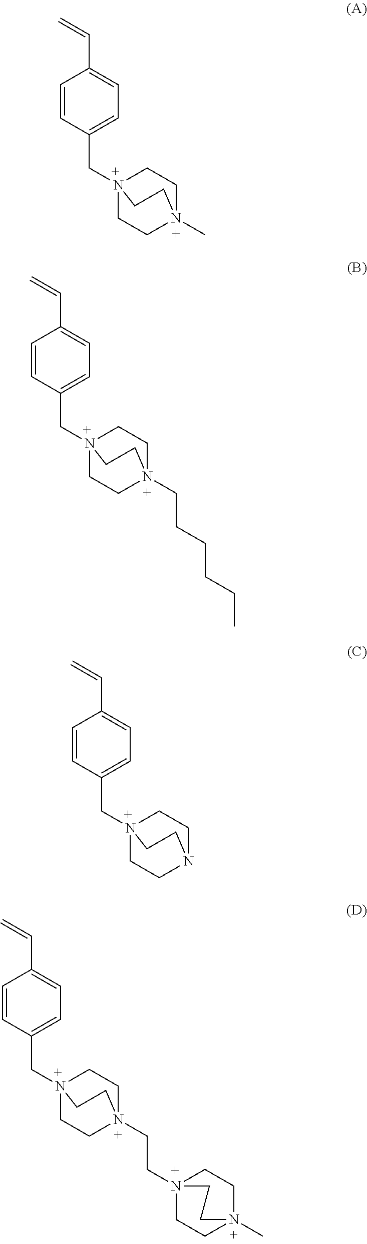

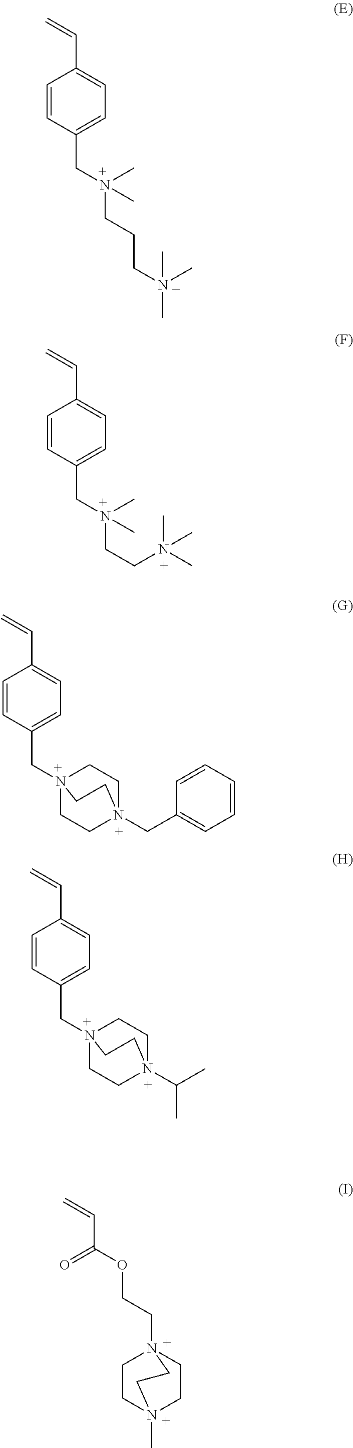

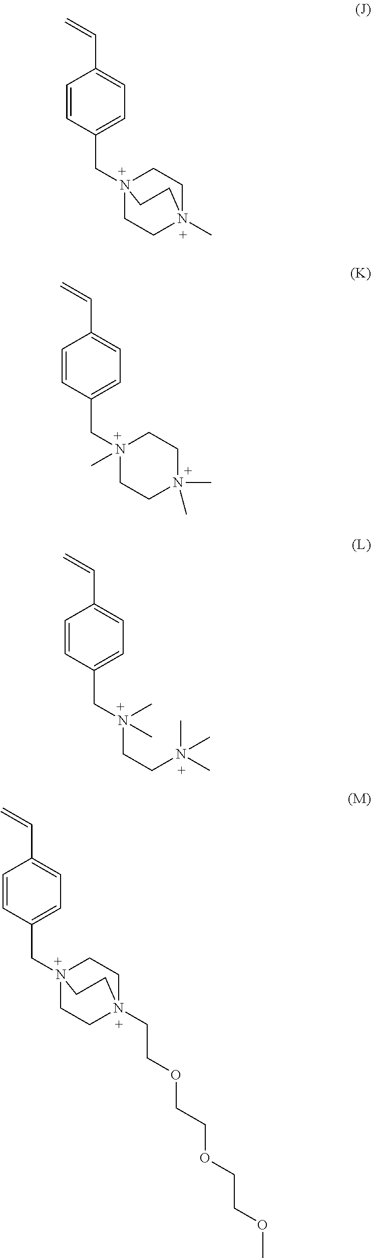

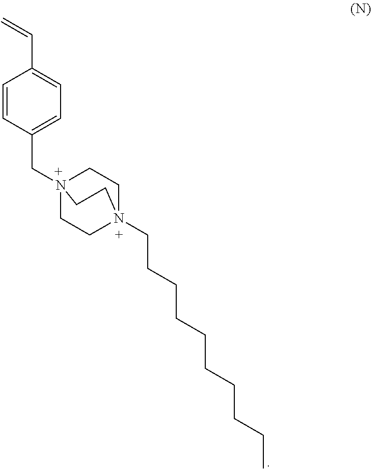

The cross-linked polymer, in accordance with example embodiments, may include a cross-linker that is devoid of the pseudo +2 point charges. The cross-linker and/or the chemical functionality of the cross-linked structure may not be particularly limited. For example, the cross-linked structure may include a styrene-based cross-linked structure (e.g., cross-linked polystyrene) or an acrylate-based cross-linked structure. In accordance with example embodiments, the cross-linked polymer may include a degree or crosslinking ranging from low crosslinking to highly crosslinked depending on the end use of the anion exchange resin. For example, the degree of crosslinking may be characterized by the amount of cross-linker present within the cross-linked polymer (e.g., the amount of cross-linker relative to the total monomer content forming the cross-linked polymer). In this regard, the degree of crosslinking may include from 1 to about 75% by weight of a cross-linker based on the total weight of the cross-linker polymer, such as at least about any of the following: 1, 3, 5, 10, 15, 20, 25, 30, and 35% by weight of a cross-linker based on the total weight of the cross-linker polymer, and/or at most about any of the following: 75, 70, 65, 60, 55, 50, 45, 40, and 35% by weight of a cross-linker based on the total weight of the cross-linker polymer.

In accordance with example embodiments, the cross-linked polymer has a nitrogen atom content from about 3 to about 15% by weight, such as at least about any of the following: 3, 4, 5, 6, 7, and 8% by weight, and/or at most about any of the following: 15, 12, 10, 9, and 8% by weight. The nitrogen content may be determined using elemental analysis (e.g., combustion analysis). Additionally, or alternatively, the cross-linked polymer includes from about 1.5 to about 4 mmol of dications per gram of the cross-linked polymer, such as at least about any of the following: 1.5, 1.6, 1.8, 2, 2.2, and 2.4 mmol of dications per gram of the cross-linked polymer, and/or at most about any of the following: 4, 3.8, 3.5, 3.2, 3, 2.8, 2.6 and 2.4 mmol of dications per gram of the cross-linked polymer.

The anion exchange resin, in accordance with example embodiments, may include a plurality of particulates. For example, the plurality of particulates may have an average particle size from about 50 to about 1500 microns (e.g., measured by the largest diameter of a particulate), such as at least about any of the following: 50, 60, 80, 90, 100, 120, 140, 150, 180, 200, 220, 250, 280, 300, 320, 350, 380, 400, 420, 450, 480, and 500 microns, and/or at most about any of the following: 1500, 1200, 1000, 980, 950, 920, 900, 880, 850, 820, 800, 780, 750, 720, 700, 680, 650, 620, 600, 580, 550, 520, and 500 microns. Additionally, or alternatively, about 90% by number of the plurality of particulates reside within 1 to 20% of the average particle size, such as from at least about any of the following: 1, 3, 5, 8, and 10% of the average particle size, and/or at most about any of the following: 20, 18, 15, 12, and 10% of the average particle size.

In accordance with example embodiments, the anion exchange resin includes a porous structure including a plurality of pores throughout the anion exchange resin. The plurality of pores, for example, may have an average pore diameter from about 1 to about 10,000 nanometers (nm), such as at least about any of the following: 1, 2, 3, 5, 8, 10, 15, 20, 25, 30, 35, 40, 45, 50, 80, 100, 120, 150, 200, 300, 400, 500, 600, 700, 800, 900, and 1000 nm, and/or at most about any of the following: 10,000, 9,000, 8,000, 7,000, 6,000, 5,000, 4,000, 3,000, 2,000, and 1,000 nm.

In accordance with example embodiments, the anion exchange resin may have a bulk density from 20 to about 100 pounds per cubic foot (lb/ft³), such as at least about any of the following: 20, 30, 40, and 50 lb/ft³, and/or at most about any of the following: 100, 90, 80, 70, 60, and 50 lb/ft³.

The anion exchange resin, in accordance with example embodiments, may sequester from about 50% to about 100% by weight of an initial quantity of a target material (e.g., such as those enumerated above) in a fluid (e.g., gas and/or liquid), such as at least about any of the following: 50, 60, 70, 80, and 85% by weight of an initial quantity of a target material in a fluid, and/or at most about any of the following: 100, 99, 98, 97, 95, 90, 88, 85, and 80% by weight of an initial quantity of a target material in a fluid. As noted above, the target material may include one or more PFAS, one or more heavy metals, or carbon dioxide (among other materials).

In accordance with example embodiments, the anion exchange resin has a sequestering capacity for one or more PFAS from about 1000 to about 3500 mg of PFAS per gram of the anion exchange resin (e.g., the cross-linked polymer), such as at least about any of the following: 1000, 1200, 1400, 1500, 1600, 1800, and 2000 mg of PFAS per gram of the anion exchange resin, and/or at most about any of the following: 3500, 3400, 3200, 3000, 2800, 2600, 2500, 2400, 2200, and 2000 mg of PFAS per gram of the anion exchange resin. In this regard, the anion exchange resin provides a significant sequestering capacity per unit weight of the anion exchange resin. In accordance with example embodiments, the anion exchange resin has a sequestering capacity for carbon dioxide from about 0.1 to about 5 mmol per gram of the anion exchange resin (e.g., the cross-linked polymer), such as at least about any of the following: 0.1, 0.2, 0.4, 0.5, 0.6, 0.8, and 1 mmol per gram of the anion exchange resin (e.g., the cross-linked polymer), and/or at most about any of the following: 5, 4.5, 4, 3.5, 3, 2.5, 2, 1.5, and 1 mmol per gram of the anion exchange resin (e.g., the cross-linked polymer). In this regard, the anion exchange resin provides a significant sequestering capacity per unit weight of the anion exchange resin.

In accordance with example embodiments, the anion exchange resin exhibits a selectivity for sequestering shorter chain PFAS, such as those most commonly used in commerce, relative to long chain PFAS. For example, the anion exchange resin may have a first sequestering-sequestering ratio (SSR #1) between C5 and C8 perfluoroalkyl ether carboxylic acids, a class of PFAS, from about 1.2:1 to about 1.8:1 on a weight/weight basis, such as at least about any of the of the following: 1.2:1, 1.3:1, 1.4:1 and 1.5:1, and/or at most about any of the following: 1.8:1, 1.7:1, 1.6:1, and 1.5:1. Additionally or alternatively, the anion exchange resin may have a second sequestering-sequestering ratio (SSR #2) between C5 and C9 perfluoroalkyl ether carboxylic acids, a class of PFAS, from about 1.2:1 to about 1.8:1 on a weight/weight basis, such as at least about any of the of the following: 1.2:1, 1.3:1, 1.4:1 and 1.5:1, and/or at most about any of the following: 1.8:1, 1.7:1, 1.6:1, and 1.5:1. Additionally or alternatively, the anion exchange resin may have a third sequestering-sequestering ratio (SSR #3) between C6 and C8 perfluoroalkyl ether carboxylic acids, a class of PFAS, from about 1.2:1 to about 1.8:1 on a weight/weight basis, such as at least about any of the of the following: 1.2:1, 1.3:1, 1.4:1 and 1.5:1, and/or at most about any of the following: 1.8:1, 1.7:1, 1.6:1, and 1.5:1. Additionally or alternatively, the anion exchange resin may have a fourth sequestering-sequestering ratio (SSR #4) between C6 and C9 perfluoroalkyl ether carboxylic acids, a class of PFAS, from about 1.2:1 to about 1.8:1 on a weight/weight basis, such as at least about any of the of the following: 1.2:1, 1.3:1, 1.4:1 and 1.5:1, and/or at most about any of the following: 1.8:1, 1.7:1, 1.6:1, and 1.5:1. Additionally or alternatively, the anion exchange resin may have a fifth sequestering-sequestering ratio (SSR #5) between C5 and C8 perfluoroalkyl carboxylic acids, a class of PFAS, from about 1.2:1 to about 2.5:1 on a weight/weight basis, such as at least about any of the of the following: 1.2:1, 1.3:1, 1.4:1, 1.5:1, 1.6:1, 1.7:1, and 1.8:1 and/or at most about any of the following: 2.5:1, 2.4:, 2.3:1, 2.2:1, 2.1:1, 2:1, 1.9:1, and 1.8:1. Additionally or alternatively, the anion exchange resin may have a sixth sequestering-sequestering ratio (SSR #6) between C5 and C9 perfluoroalkyl carboxylic acids, a class of PFAS, from about 1.2:1 to about 2.5:1 on a weight/weight basis, such as at least about any of the of the following: 1.2:1, 1.3:1, 1.4:1, 1.5:1, 1.6:1, 1.7:1, and 1.8:1 and/or at most about any of the following: 2.5:1, 2.4:, 2.3:1, 2.2:1, 2.1:1, 2:1, 1.9:1, and 1.8:1. Additionally or alternatively, the anion exchange resin may have a seventh sequestering-sequestering ratio (SSR #7) between C6 and C8 perfluoroalkyl carboxylic acids, a class of PFAS, from about 1.2:1 to about 2.5:1 on a weight/weight basis, such as at least about any of the of the following: 1.2:1, 1.3:1, 1.4:1, 1.5:1, 1.6:1, 1.7:1, and 1.8:1 and/or at most about any of the following: 2.5:1, 2.4:, 2.3:1, 2.2:1, 2.1:1, 2:1, 1.9:1, and 1.8:1. Additionally or alternatively, the anion exchange resin may have an eighth sequestering-sequestering ratio (SSR #8) between C6 and C9 perfluoroalkyl carboxylic acids, a class of PFAS, from about 1.2:1 to about 2.5:1 on a weight/weight basis, such as at least about any of the of the following: 1.2:1, 1.3:1, 1.4:1, 1.5:1, 1.6:1, 1.7:1, and 1.8:1 and/or at most about any of the following: 2.5:1, 2.4:, 2.3:1, 2.2:1, 2.1:1, 2:1, 1.9:1, and 1.8:1.

In another aspect, example embodiments provide methods of making an anion exchange resin, such as those described and disclosed herein. The method of making an anion exchange resin may include the following steps: (i) providing a diamine compound, such as a cyclic diamine compound; (ii) reacting the diamine compound with an organohalogen compound, such as an alkyl halide, an aryl halide, or an acyl halide, to form a first precursor compound (e.g., a salt); (iii) reacting the first precursor compound with an unsaturated organohalogen compound, such as a vinyl halide, to form a dicationic unsaturated monomer, such as a dicationic vinyl monomer; (iv) reacting the dicationic unsaturated monomer with a cross-linker having at least two reactive functionalities, such as two vinyl groups, to form a cross-linked polymer. In accordance with example embodiments, the diamine compound is DABCO. As noted above, the organohalogen reacted with the diamine compound may not be particularly limited, but may include at least one degree of unsaturation (e.g., a C═C bond or a C ≡C bond). The location of the at least one degree of unsaturation may be located at a terminal end of the organohalogen is generally illustrated above. In accordance with example embodiments, the cross-linker may include at least 2 or at least three reactive sites (e.g., a C═C bond or a C≡C bond).

In another aspect, example embodiments provide a device including a chamber defining an interior cavity and having at least a fluid inlet and optionally a fluid outlet, in which each of the fluid inlet and fluid outlet (if present) is in operative communication with the interior cavity. The device also includes an anion exchange resin, such as those described and disclosed herein, provided in the form of a plurality of particulates confined within the interior cavity. In this regard, a fluid (e.g., liquid and/or gaseous fluid) having a target material (e.g., one or more compounds of interest) may enter into the interior cavity via the fluid inlet, contact and/or interact with the anion exchange resin, and exit the interior chamber either through the same inlet or a separate fluid outlet. The device may also include a fluid distribution system (e.g., laterals) located inside the interior cavity and in operative communication with the fluid inlet. In this regard, the fluid distribution system may disperse an incoming feed fluid for removal of a target material throughout a wider cross-section of the anion exchange resin housed within the interior cavity, which may provide a more even flow through a bed or column of the anion exchange resin housed inside the interior cavity.

In another aspect, example embodiments provide a method of sequestering a target material of interest (e.g., one or more compounds of interest) from a fluid (e.g., liquid and/or gaseous fluid) containing the target material. The method may include a step of contacting the fluid containing the target material with an anion exchange resin, such as those described and disclosed herein. For example, the contacting step may include flowing the fluid containing the target material across or through a bed of the anion exchange resin. For example, the fluid containing the target material may be pumped across and/or through a bed of the anion exchange resin in a single pass or multiple passes (e.g., recirculating the fluid containing the target material through the bed or column of anion exchange resin) until a desired reduction in the target material (e.g., one or more PFAS, one or more heavy metals, carbon dioxide, etc.) is realized or detected.

In accordance with example embodiments, the target material is carbon dioxide and the anion exchange resin is provided in a dry state, in which the fluid includes a gaseous medium including the carbon dioxide. The method may also include a desorption operation including a moisture swing step of contacting the anion exchange resin having carbon dioxide sequestered thereon with moisture to release at least a portion of the sequestered carbon dioxide. By way of example, the moisture may be provided by a stream of humid air, wherein the humid air has a relative humidity from about 65 to about 100%, such as at least about any of the following: 65, 70, 75%, and/or at most about any of the following: 100, 95, 90, 85, 80, and 75%. The method, for example, may include a direct air capture process sequestering carbon dioxide from ambient air. In accordance with example embodiments, a difference in relative humidity between the humid air and the gaseous medium including the carbon dioxide is from about 20 to about 100%, such as at least about any of the following: 20, 30, 40 and 50%, and/or at most about any of the following: 100, 90, 80, 70, 60, and 50%.

In accordance with example embodiments, the method may include pressure and/or temperature swing operation in lieu of or in conjunction with a moisture swing operation. In this regard, the anion exchange resin may be housed within a moisture swing column, a temperature swing column, and/or a pressure swing column.

For instance, an adsorption column housing the anion exchange resin may capture or retain a gas, such as carbon dioxide, from an airflow being conveyed through the adsorption column under a first set of operating conditions, such as a first pressure, temperature, and/or moisture level, and desorb or release previously captured or retained carbon dioxide under a second set of operating conditions, such as a second pressure that is lower than the first pressure and/or at a second moisture level that is greater than a first moisture level. Accordingly, the column housing the anion exchange resin may be operatively connected to a vacuum source. The vacuum source is not limited to any particular device, but may include a vacuum pump, a fan, steam ejector, or other device capable of changing, e.g., raising or reducing, the pressure inside the adsorption column 10.

The term “temperature swing”, as used herein, refers to a process that relies on temperature differences and associated pressure differences for different operating conditions. The term “pressure swing” (PSA), as used herein, refers to a process used to separate a gas species (e.g., carbon dioxide) from a mixture of gases (e.g., air) under pressure according to the gas species' (e.g., carbon dioxide) molecular characteristics and affinity for a sorbent material (e.g., anion exchange resin).

### EXAMPLES

The present disclosure is further illustrated by the following examples, which in no way should be construed as being limiting. That is, the specific features described in the following examples are merely illustrative and not limiting.

### Example Set 1

As noted above, anion ion exchange resins are an alternative technology which has been proven to be both more efficient and cost effective for the remediation of PFAS. These materials use their inherent cationic charge to attract PFAS which is predominately anionic. Despite the improvements of anion ion exchange resins these materials still require further development to improve their adsorption capacity for PFAS, their selectivity for PFAS, as well as their ability to remediate shorter chain PFAS. In order to further improve the performance of anion ion exchange resins, example embodiments provide anion exchange resin including a plurality of dicationic groups incorporated onto or within a cross-linked polymer. The following anion exchange resins were produced according to Reaction Scheme 1 and studied for their use in the sequestering a variety of PFAS. Reaction Scheme 1 is illustrated below for the production of cross-linked polymers including a methyl-DABCO group and a hexyl-DABCO group.

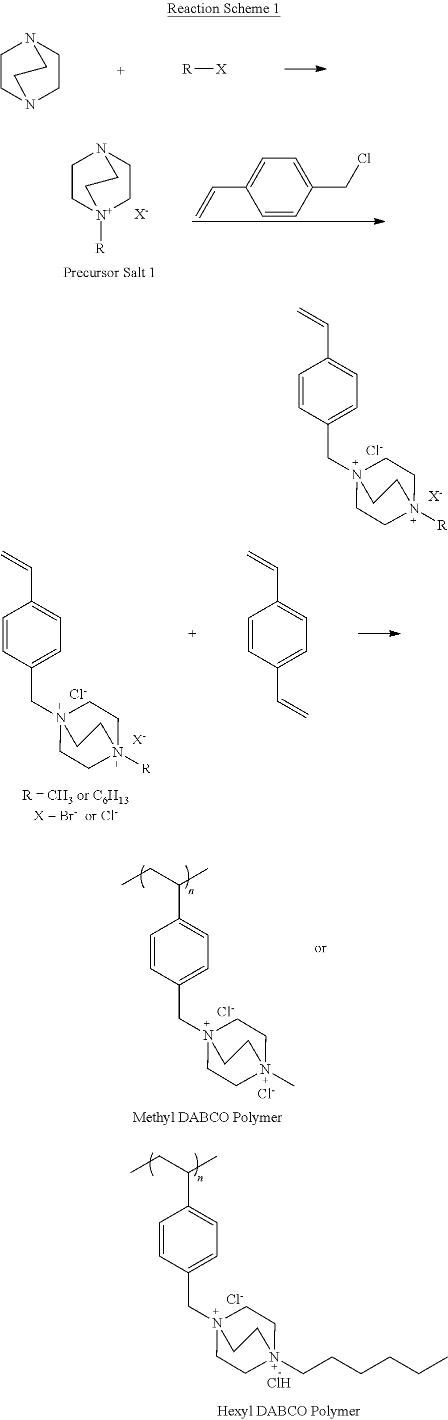

As noted above, current state of the art anion exchange resins relies on permanently charged monovalent functional groups, such as quaternized trimethylamine, to attract charged pollutants with complimentary charge. The present examples, however, leverage a new approach where divalent functional groups are incorporated within the polymer to attract PFAS with higher affinity. However, covalent incorporation of a 2+functionality is not possible in the traditional sense due to no known organic functional groups possessing a 2+charge. These examples, however, are able to incorporate a “pseudo” 2+point charge with enhanced anion affinity. The monomers used to accomplish this are similar to those found in industrial resins but are based on the quaternized diamine DABCO rather than quaternized trimethylamine. These monomers enable the cations to be rigidly placed in close proximity, such as about 1.5 Angstroms apart, to enable both cations to impart their columbic force of attraction onto the anion (e.g., the target material). This results in a cooperative effect when an anion binds.

Once synthesized these example anion exchange resins were tested for their PFAS affinity in a number of matrices including simulated river water, drinking water, and ideal scenarios. To assess the relative performance of the examples, these examples were compared to state-of-the-art resins and GAC. Additionally, a number of tests were conducted to establish general metrics for the examples such as their adsorption kinetics and adsorption capacity. Finally, studies across many different PFAS classes were also conducted. These studies were collectively conducted to establish the efficacy of divalent anion exchange resins as compared to the monovalent state of the art and to establish future directions for further improvement of divalent resin development.

Dicationic vinyl monomers (e.g., methyl-DABCO-containing monomer and hexyl-DABCO-containing monomer) were synthesized via two SN2 reactions as outlined in Reaction Scheme 1. First DABCO underwent a reaction with a stochiometric amount of an alkyl iodide or bromide to yield the precursor salt 1. Then precursor salt 1 underwent an additional SN2 reaction with 4-vinyl benzyl chloride to yield the dicationic vinyl monomer. All monomers were characterized with proton and carbon NMR spectroscopy. Synthesis of resins was conducted with the dicationic monomers in the presence of divinyl benzene and AIBN at 55° C. for 24 hours. The resulting crosslinked gels were then pulverized and washed with brine, water, and underwent a methanol soxhlet. These materials were then dried under vacuum. To confirm the identity of the material, resins were characterized with FTIR and elemental analysis. All resin samples synthesized as well as commercial resins purchased were all pulverized and sieved using a 90 μm sieve. Two separate dicationic resins were synthesized, in which one resin contained a methyl functional group at the terminal amine (e.g., methyl-DABCO) while the other resin contained a hexyl alkyl chain at the terminal amine (e.g., hexyl-DABCO). These two resins may be referred to as generation 1 and generation 2, respectively. All removal studies were conducted in batch and were agitated on a shaker table. Analysis of PFAS components was conducted in accordance with EPA method 537.1.

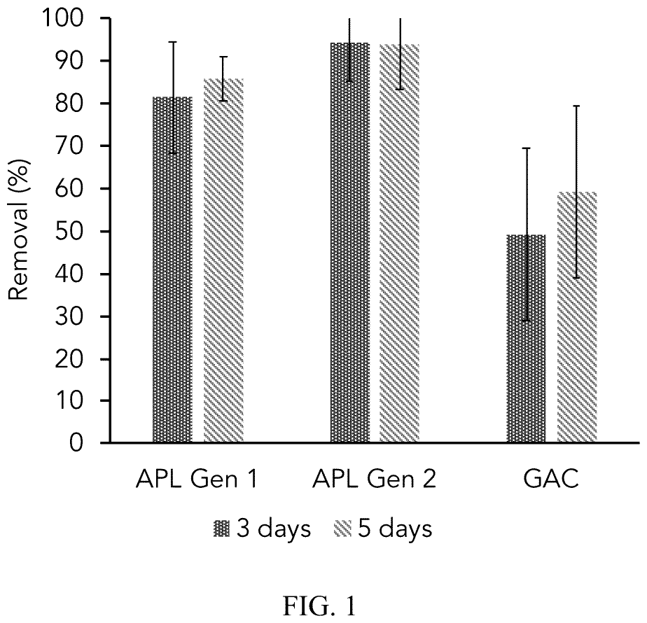

FIG. 1, for instance, illustrates a comparison for each example resin and GAC in demineralized/deionized (DI) water. Removal of 2 micrograms per liter (μg/L) of PFOA in DI water after 72 hours (h) and 120 h of contact time. Low resin loadings of 0.5 mg/L resulted in excellent removal for both generation 1 and 2 resins. Both resins also demonstrated a significant improvement in removal over granular activated carbon (GAC).

Initial studies were conducted in comparison to GAC (FILTRASORB® 300) in an ideal water matrix containing no competitive binding ions or molecules. These studies were conducted for 5 days with 2 ppb of PFOA as the pollutant of interest. Adsorbent loadings were 0.5 mg/L. From these studies it was observed that both generation 1 and generation 2 showed superior adsorption affinity as compared to GAC. Generation 2 showed the greatest removal efficiency with 94% of PFOA being adsorbed by the resin compared to 86% removal for generation 1 and 59% removal for GAC after 5 days. Additionally, it should be noted that the resin loadings used in these experiments is remarkably low and further demonstrates the high affinity of these materials.

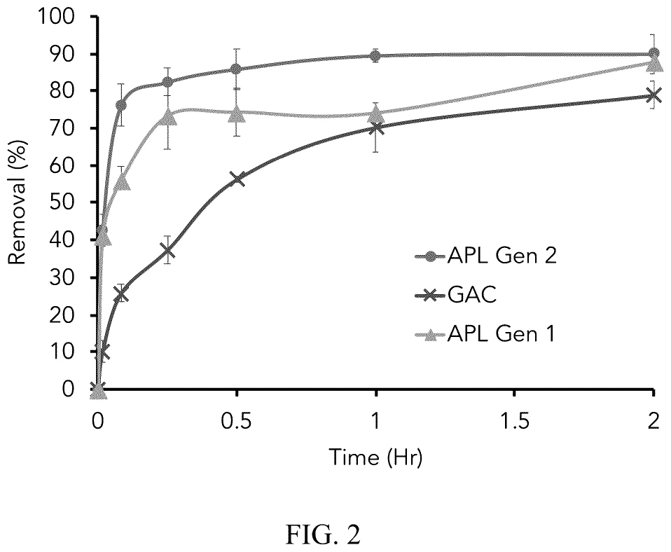

In addition to comparing the affinity of these example anion exchange resins, the kinetic removal of 2 ppb PFOA was also assessed. This study was conducted in a competitive ionic matrix meant to simulate drinking water from Baltimore Maryland. The composition of the water consisted of 0.7 mM Na₂CO₃, 1.2 mM NaCl, and 0.12 mM Na₂SO₄. An adsorbent loading of 20 mg/L of each adsorbent was used and the samples were stirred with a magnetic stir bar. GAC showed the slowest removal kinetics requiring approximately 1 hour to reach equilibrium while both generation 1 and generation 2 resins required 15 minutes and 5 minutes respectively. These fast kinetics can be attributed to the hydrophilicity of the resins which has previously been described as a necessary component to rapid removal kinetics in water. In this regard, FIG. 2 provides the visual illustration of Removal of 2 μg/L of PFOA by 20 mg/L of adsorbent in 0.7 mM Na₂CO₃, 1.2 mM NaCl, and 0.12 mM Na₂SO₄. Resins according to example embodiments (designated “APL” in the drawings) showcased exceptionally and unexpectedly fast removal as compared to granular activated carbon (GAC).

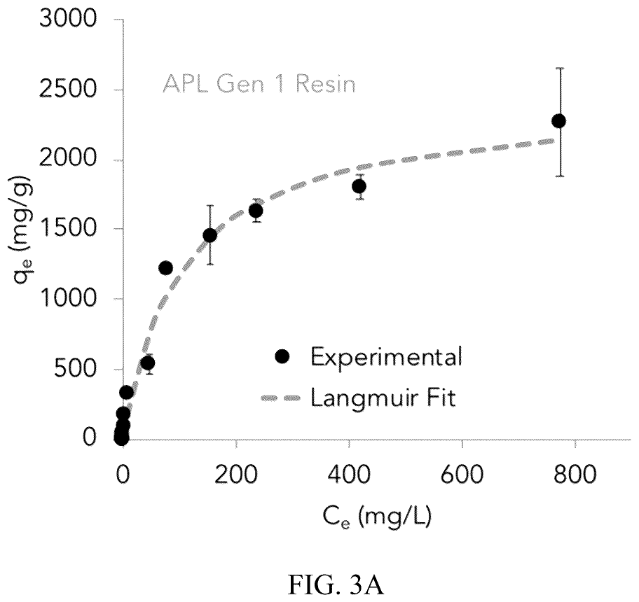

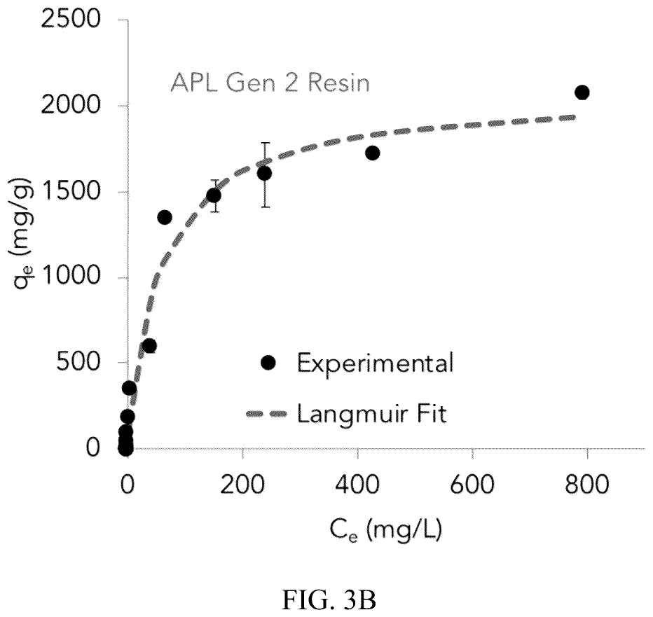

Adsorption capacity of PFOA was also assessed for both generations of resins. Adsorption capacity was assessed through the construction of an adsorption isotherm performed as a series of batch removal experiments at increasing PFOA concentrations. These studies were performed in an ideal water matrix without the presence of competitive adsorbates. Both isotherms were fit to a Langmuir model which gave a calculated theoretical adsorption capacity. Both generations of resins exhibited remarkably high adsorption capacities of 2079 mg/g for generation 2 and 2446 mg/g for generation 1. FIGS. 3A-3B illustrate the PFOA adsorption isotherms by 100 mg/L of adsorbent in DI water for the above. The Langmuir model was fit to both isotherms and gave a calculated maximum capacity of 2079 mg/g and 2446 mg/g for generation 2 and 1, respectively. These capacities are to our knowledge the highest known adsorptive capacities for PFOA ever reported with the previous record set by the commercial resin Amberlite IRA 910 with an adsorptive capacity of 1446 mg/g.

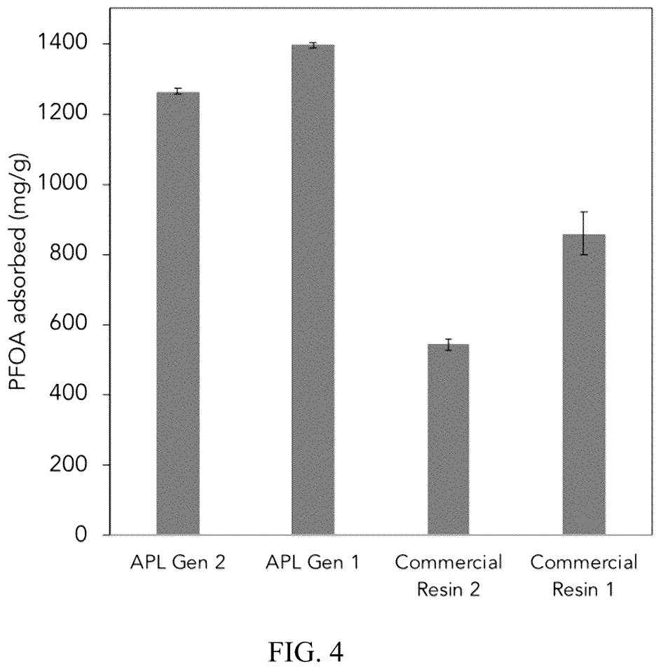

To further investigate the remarkably high adsorption capacities of the example resins, further experiments were conducted side by side with industry leading resins. Commercial resin 1 is the previous record holder for PFOA adsorption capacity, AMBERLITE® IRA910. Commercial resin 2 is one of the leading ion exchange resins on the market for PFAS remediation from PUROLITE® named PFA694E. These commercial materials along with the example resins were challenged with 300 ppm of PFOA with an adsorbent loading of 100 mg/L for 6 days in an ideal water matrix. Both the generation 1 and generation 2 resins were able to adsorb 1263 mg/g and 1394 mg/g of PFOA, respectively which was considerably more than both commercial resin 1 and 2 which only removed 859 mg/g and 543 mg/g, respectively. This experiment further alludes to the remarkably high adsorption capacity of these dicationic materials according example embodiments. FIG. 4 is a graph for the data discussed above.

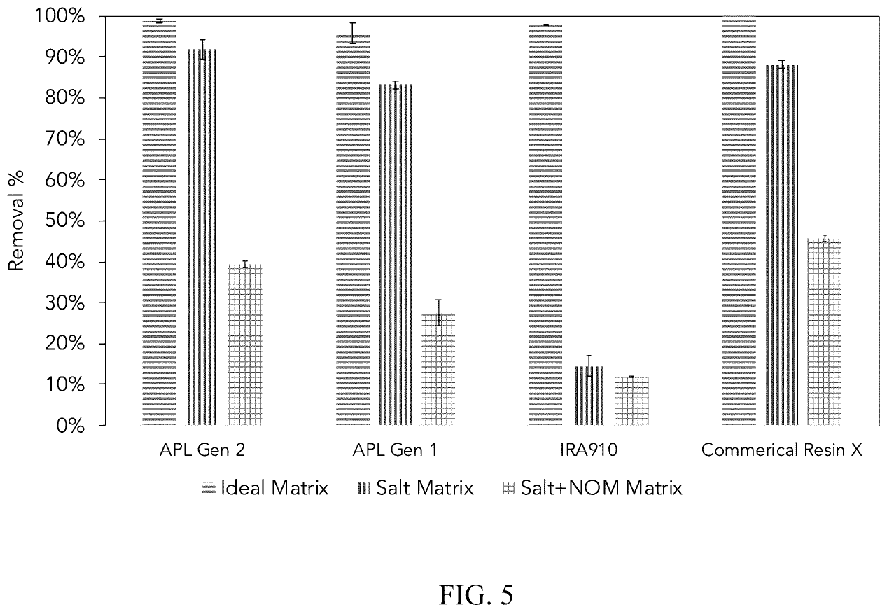

Apart from assessing the kinetics and adsorption capacity of these materials, PFAS selectivity is also a crucial parameter that dictates efficient resin performance. Resins must be able to resist competitive fouling due the presence of other types of ions or hydrophobic molecules. To assess the ability for the example resins to resist fouling experiments in 3 matrices were conducted: an ideal matrix; a salt matrix; and a salt+NOM matrix. The ideal matrix contained no competitive adsorbates, the salt matrix contained salts meant to mimic the salt content of Baltimore, Maryland's drinking water, and the salt+NOM matrix contained the same salt matrix with the addition of natural organic matter (NOM) at 3 mg/L meant to mimic what could be found in river water. Across all three matrices the removal of 4 ppb PFOA was compared with generation 1 and 2 resins and commercial resins 1 and 2. Resin loadings were 2 mg/L. This study showed that commercial resin 1 was dramatically fouled by the salt matrix resulting in a drop of PFOA removal from 98% removal to 15% removal. Commercial resin 2 as well as generation 1 and 2 were not dramatically fouled. However, generation 2 did appear to have significantly higher resistance to ionic fouling as compared to generation 1 with generation 2 removing 92% and generation 1 removing 83%. Generation 2 also remained competitive with the state of the art (commercial resin 2). However, commercial resin 2 experienced slightly less NOM fouling resulting in 46% removal as compared to generation 2's 39% removal. FIG. 5 illustrates the data from this study, namely removal of 4 μg/L of PFOA by 2 mg/L of adsorbent in DI water (left columns), an ionic matrix with 0.7 mM Na₂CO₃ 1.2 mM NaCl and 0.12 mM Na₂SO₄ (middle columns), and the same ionic matrix with the addition of 3 mg/L natural organic matter (NOM) (right columns). Both example resins were compared to the ion exchange resin AMBERLITE® IRA910 (commercial resin 1) and PUROLITE® PFA694E (commercial resin 2). Generation 2 resin superior resistance to ionic and NOM fouling compared to both the generation 1 and commercial resin 1.

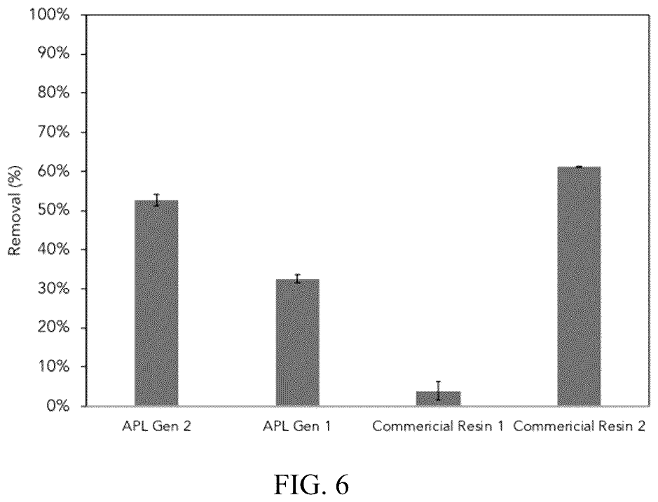

Further analysis into the effects of fouling were investigated in the context of other types of PFAS as well. Specifically, the short chain PFAS perfluorobutanoic acid (PFBA) is one of the most difficult to remove PFAS. A removal experiment of 4 ppb PFOA in the presence of the salt+NOM matrix was conducted. We found a similar trend to what was observed with PFOA where commercial resin 1 was fouled to the point of almost no measurable removal. Resin generation 2 and 1 were also fouled however generation 2 resisted fouling significantly better than generation 1 resulting in 53% removal and 33% removal respectively. Generation 2 remained competitive with commercial resin 2 which removed 61%. FIG. 6, illustrates the test results, namely removal of 4 μg/L of PFBA by 40 mg/L of adsorbent in 0.7 mM Na₂CO₃, 1.2 mM NaCl, and 0.12 mM Na₂SO₄. Both APL resins according to example embodiments were compared to the ion exchange resin AMBERLITE® IRA910 (commercial resin 1) and PUROLITE® PFA694E (commercial resin 2). Generation 2 resin superior resistance to ionic and NOM fouling compared to both the generation 1 and commercial resin 1. Commercial resin 2 demonstrated similar performance to one example embodiment's (APL) generation 2 resin.

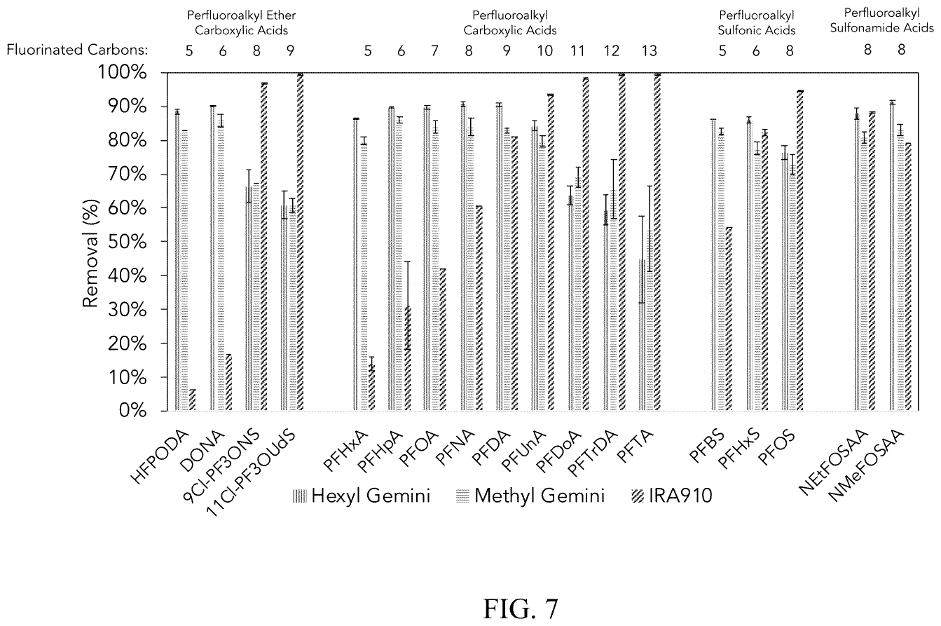

Finally, the selectivity of the resins for specific PFAS types were also tested in a complex mixture of 18 PFAS at approximately 700 ppt of each PFAS. This test was conducted in the simulated Baltimore ionic matrix (see above) with 20 mg/L of polymer for 2 days of exposure. Typically, ion exchange resins have a greater propensity to remove PFAS of longer chain length due to the increase in hydrophobicity of the adsorbate. This trend was seen clearly with the IRA910 resin. For example, only 14% of the short chain PFAS Perfluorohexanoic acid (PFHxA) was removed as compared to 100% of the long chain PFAS perfluorotetradecanoic acid (PFTA). Interestingly, the APL resins according to example embodiments observed the opposite trend where shorter chain PFAS seemed to have higher affinity for the resin over that of longer chain PFAS. For PFHxA and PFTA generation 2 removed 86% and 45% respectively. To my knowledge this trend has never been observed in an ion exchange resin. This reversal in trend may be due to the increased hydrophilicity of the +2 cationic groups which favor interaction with more hydrophilic PFAS. FIG. 7, illustrates the test results, namely removal of a mixture of 18 PFAS at approximately 0.7 μg/L of each PFAS by 40 mg/L of adsorbent in 0.7 mM Na₂CO₃, 1.2 mM NaCl, and 0.12 mM Na₂SO₄. Resins according to example embodiments (designated “APL”) were compared to AMBERLITER IRA910. The example resins demonstrated a reversal in the selectivity for shorter chain PFAS over that of IRA910 which was more selective for long chain PFAS.

The foregoing studies have demonstrated how cations can be rigidly paired within resins to create pseudo 2+point charges, which can be leveraged to attract PFAS. These example resins were shown to have high affinity for PFOA requiring minimal polymer loadings to achieve greater than 90% removal and had higher removal percentages than leading GAC and IX technologies. Additionally, the example resins were shown to have fast kinetics reaching equilibrium in 15 minutes or less, which was far superior to GAC which required 1 hour to reach equilibrium. Finally, the example resins have exceptional capacity for PFOA reaching greater than 2000 mg/g of PFOA for both resins. These capacities are some of the highest capacities for PFOA reported to date. It appears that the incorporation of 2+charges offer significant advantages over the incorporation of monovalent charges. Finally, these example resins were also shown to remove a broad range of PFAS and have enhanced selectivity for short chain PFAS over that of long chain PFAS.

### Example Set 2

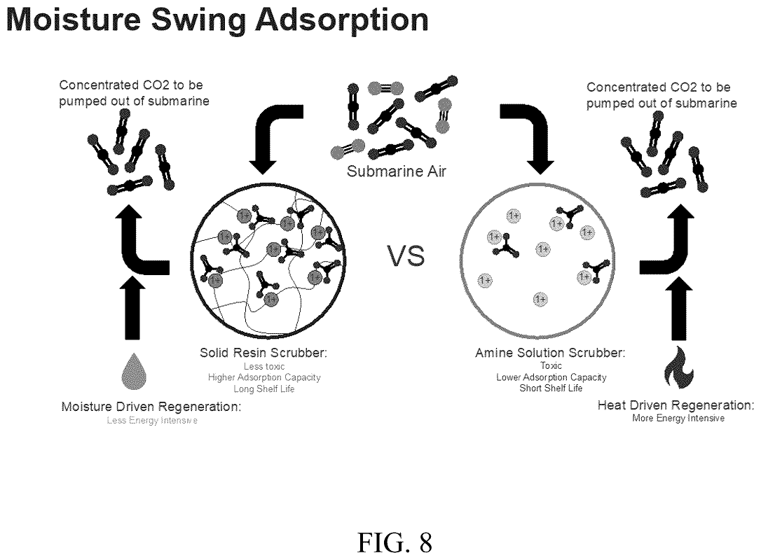

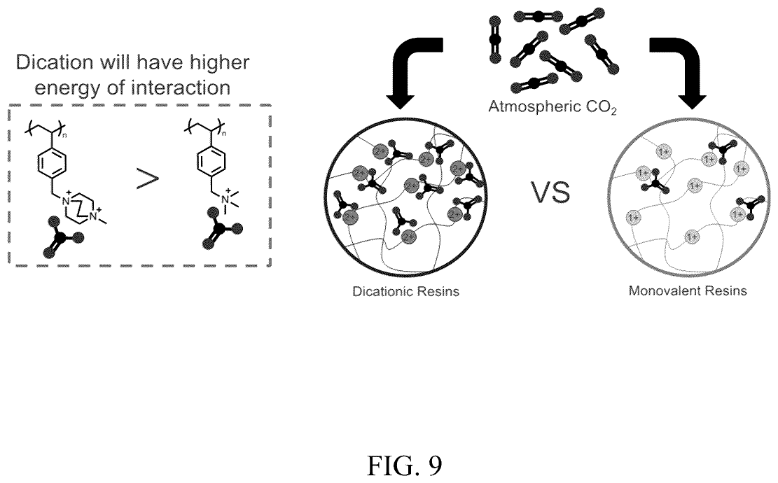

The generation 2 resin from Example Set 1 was further analyzed for the capture of carbon dioxide, which could provide numerous end-use applications (e.g., removal of carbon dioxide from confined spaces, vehicles, etc.). FIG. 8, for example, provides a schematic of possible removal for carbon dioxide from air, such as from the air in an enclosed space or vessel (such as a submarine, for example), in which air is conveyed or pulled into and through a solid resin scrubber housing the anion exchange resin in a dry state. A moisture swing operation (e.g., an operation including moisture swing adsorption) can be performed to desorb carbon dioxide sequestered onto the anion exchange resin and pumped out of the system. FIG. 9 provides a visual contrast between the dicationic example resins compared to traditional monocationic resins.

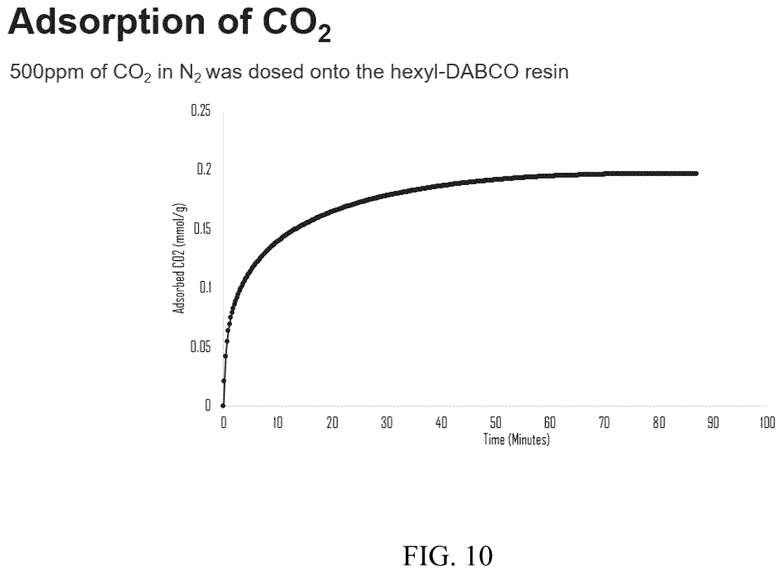

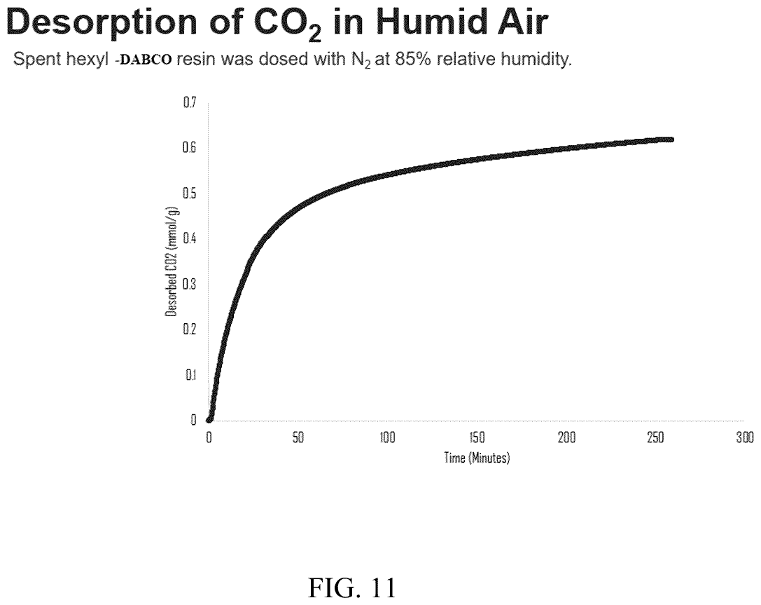

In this study, 500 ppm of carbon dioxide in nitrogen gas was dosed onto the generation 2 resin. FIG. 10 generally illustrates adsorption rates of CO₂ and, more particularly, illustrates the amount of carbon dioxide sequestered by the generation 2 resin over time. FIG. 11 illustrates the subsequent desorption of carbon dioxide, in humid air (e.g., 85% relative humidity), that was previously sequestered onto the generation 2 resin. This example set illustrates just one additional application for the anion exchange resins described and disclosed herein.

Many other modifications and other example embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the spirit or scope of the appended claims. In addition, it will be understood that aspects of these various example embodiments may be interchanged in whole or in part. Furthermore, different combinations of elements and/or functions than those explicitly described above are also contemplated as may be set forth in some of the appended claims. In cases where advantages, benefits, or solutions to problems are described herein, it will be appreciated that such advantages, benefits, and/or solutions may be applicable to some example embodiments, but not necessarily all example embodiments. Thus, any advantages, benefits, and/or solutions described herein should not be construed as being critical, required, or essential to all embodiments or to that which is claimed herein. Although specific terms are employed herein, they are used in a generic and descriptive sense only and not for purposes of limitation.

What is claimed is:

1. An anion exchange resin, comprising:
a cross-linked polymer including a plurality of pseudo +2 point charges comprising dicationic groups, wherein
the dicationic groups include a first cationic group and a second cationic group, and
a distance between the first cationic group and the second cationic group is from about 1 Angstrom to about 10 Angstroms.

2. The anion exchange resin of claim 1, wherein
the cross-linked polymer further includes a plurality of cyclic organic groups including a respective dicationic group, and
the plurality of cyclic organic groups comprises from about 1 ring to about 6 rings.

3. The anion exchange resin of claim 2, wherein each ring comprises from about 3 carbon atoms to about 12 carbon atoms.

4. The anion exchange resin of claim 2, wherein the plurality of cyclic organic groups further comprises heterocyclic groups comprising carbon atoms and nitrogen atoms forming part of a structure of the rings.

5. The anion exchange resin of claim 2, wherein the cross-linked polymer further includes a plurality of 1,4-Diazabicyclo[2.2.2]octane (DABCO) groups each including a respective dicationic group.

6. The anion exchange resin of claim 5, wherein each DABCO group independently from each other has a structure according to structure (1): 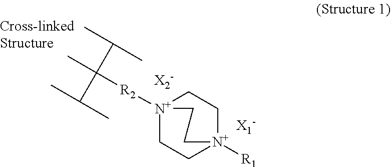
wherein,
R₁ is selected from a saturated or unsaturated linear hydrocarbon radical, a saturated or unsaturated branched hydrocarbon radical, a saturated or unsaturated linear hydrocarbon radical substituted with at least one heteroatom, a saturated or unsaturated branched hydrocarbon substituted with at least one heteroatom, a saturated or unsaturated cyclic hydrocarbon radical, a saturated or unsaturated heterocyclic hydrocarbon radical; wherein the at least one heteroatom is selected from an oxygen atom or a nitrogen atom,
R₂ is selected from an acrylate functional group diradical, a saturated or unsaturated linear hydrocarbon diradical, a saturated or unsaturated branched hydrocarbon diradical, a saturated or unsaturated linear hydrocarbon diradical substituted with at least one heteroatom, a saturated or unsaturated branched hydrocarbon diradical substituted with at least one heteroatom, a saturated or unsaturated cyclic hydrocarbon diradical, a saturated or unsaturated heterocyclic hydrocarbon diradical; wherein the at least one heteroatom is selected from an oxygen atom or a nitrogen atom, and
X₁ and X₂ are each a halide atom.

7. The anion exchange resin of claim 6, wherein R₁ includes from 1 to 6 additional DABCO groups, including at least one of any of the following: 1, 2, and 3 additional DABCO groups, and at most any of the following: 6, 5, 5, and 3 additional DABCO groups.

8. The anion exchange resin of claim 7, wherein R₁ includes a C1-C6 hydrocarbon between each additional DABCO group.

9. The anion exchange resin of claim 6, wherein R₁ includes from about 1 carbon atom to about 50 carbon atoms, including at least one of any of the following: 1, 2, 3, 6, 8, 10, 12, 15, 18, 20, 22, and 25 carbon atoms, and at most any of the following: 50, 48, 45, 42, 40, 38, 35, 32, 30, 28, and 25 carbon atoms.

10. The anion exchange resin of claim 6, wherein R₁ includes at least one monocationic group comprising a quaternary ammonium compound.

11. The anion exchange resin of claim 1, wherein the cross-linked polymer has a nitrogen atom content from about 3 percent (%) by weight to about 15% by weight.

12. The anion exchange resin of claim 1, wherein the cross-linked polymer includes from about 1.5 millimole (mmol) to about 4 mmol of dications per gram of the cross-linked polymer.

13. The anion exchange resin of claim 1, wherein the anion exchange resin comprises a plurality of particulates.

14. The anion exchange resin of claim 13, wherein an average particle size of particles in the plurality of particulates is from about 50 microns to about 1500 microns.

15. The anion exchange resin of claim 1, wherein the anion exchange resin has a sequestering capacity for one or more per- and poly-fluoroalkyl substances (PFAS) from about 1000 milligrams (mg) to about 3500 mg of PFAS per gram of the anion exchange resin.

16. A device, comprising:
(i) a chamber defining an interior cavity and having at least a fluid inlet and optionally a fluid outlet each being in operative communication with the interior cavity; and
(ii) an anion exchange resin, comprising a cross-linked polymer including a plurality of pseudo +2 point charges comprising dicationic groups, wherein
the dicationic groups include a first cationic group and a second cationic group,
a distance between the first cationic group and the second cationic group is from about 1 Angstrom to about 10 Angstroms, and
the anion exchange resin is provided in the form of a plurality of particulates confined within the interior cavity.

17. A method of sequestering a target material of interest from a fluid containing the target material, the method comprising:
contacting the fluid containing the target material with an anion exchange resin comprising a cross-linked polymer including a plurality of pseudo +2 point charges comprising dicationic groups, wherein
the dicationic groups include a first cationic group and a second cationic group, and
a distance between the first cationic group and the second cationic group is from about 1 Angstrom to about 10 Angstroms.

18. The method of claim 17, wherein the target material comprises one or more per- and poly-fluoroalkyl substances (PFAS), one or more heavy metals, or carbon dioxide.

19. The method of claim 18, wherein
the target material is carbon dioxide and the anion exchange resin is provided in a dry state, and the fluid comprises a gaseous medium including the carbon dioxide, and
after an amount of sequestered carbon dioxide on the anion exchange resin is achieved, the method further comprises a desorption operation comprising a moisture swing step of contacting the anion exchange resin having carbon dioxide sequestered thereon with moisture to release at least a portion of the sequestered carbon dioxide.

20. A method of making an anion exchange resin, the method comprising:
(i) providing a diamine compound;
(ii) reacting the diamine compound with an organohalogen compound to form a first precursor compound;
(iii) reacting the first precursor compounds with an unsaturated organohalogen compound to form a dicationic unsaturated monomer; and
(iv) reacting the dicationic unsaturated monomer with a cross-linker having at least two reactive functionalities to form a cross-linked polymer.
